(19) United States
(12) Patent Application Publication
(10) Pub. No.: US 2010/0221930 A1
(43) Pub. Date: Sep. 2, 2010

(54) PLUG DEVICE, PLUG CONNECTOR, AND METHOD FOR PRODUCING THE PLUG CONNECTOR

(75) Inventors: Ralf Hying, Muenchen (DE); Peter Niedermeier, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/680,914

(22) PCT Filed: Oct. 2, 2007
(86) PCT No.: PCT/EP2007/060466

§ 371 Date: Mar. 31, 2010

(51) Int. Cl. H01R 12/24; H01R 12/14; H01R 43/20

(52) U.S. Cl. 439/77; 439/55; 29/843

(57) ABSTRACT

A plug device may include a printed circuit board; and a plug connector, which is soldered flat onto the printed circuit board.

The invention relates to a plug device, a plug connector and a process for manufacturing the plug device.

Quick-connect tab terminals to which cables can be crimped are known. Precisely in the case of heavy-duty connections, such cables have the disadvantage that they cause a comparatively high inductance.

The object of the invention consists in avoiding the above-mentioned disadvantages and in particular specifying a plug device which enables an efficient heavy-duty connection.

This object is achieved in accordance with the features of the independent patent claims. Developments of the invention are also given in the dependent claims.

In order to achieve the object, a plug device is specified which includes a printed circuit board and a plug connector, wherein the plug connector has been soldered flat onto the printed circuit board.

In this case, the plug connector is soldered at least partially flat onto the printed circuit board. By virtue of the flat connection, contact can be produced with at least one conductor track on the printed circuit board and thus a low inductance can be achieved.

One development is that the printed circuit board has at least one conductor track, with which contact is made by the plug connector.

Another development is that the printed circuit board has two conductor tracks, which are arranged at least partially on different sides of the printed circuit board.

In particular by virtue of correspondingly wide conductor tracks, in addition the stray inductance between the lines or conductor tracks can be reduced.

A further development is that the printed circuit board includes a flexible printed circuit board, in particular a circuit board or a Flex PCB.

Preferably, the printed circuit board can be designed to be pliable.

In particular, the printed circuit board can include a plurality of plug connectors, which have each been soldered flat onto the printed circuit board. Advantageously, contact can be made with the plurality of plug connectors via a plurality of conductor tracks on the printed circuit board.

It is also possible for the plug connector to have a plurality of contacts which are electrically isolated from one another, contact being made with in each case one contact thereof via at least one conductor track on the printed circuit board.

In particular, at least one contact can have no electrical function and can act, for example, as an insertion aid or as a coding.

It is therefore one development that the printed circuit board has at least two lines, which are connected to at least one plug connector.

Furthermore, the plug connector can be a quick-connect tab terminal.

One configuration consists in that the plug connector has a means for locking or for releasing the locking. Thus, for example, a quick-connect tab terminal can be provided with a FASTON principle.

An alternative embodiment is that the plug connector has been soldered onto the printed circuit board using a reflow method.

A further development is that the plug connector has a fixing option for securing the position of the plug connector on the printed circuit board.

Such a fixing option can be used to secure a position of the plug connector prior to the actual soldering process, with the result that this plug connector substantially cannot slide during the soldering, for example by means of the reflow method.

One development consists in that the fixing option includes a depression or an elevation or a cutout.

In particular, the plug connector can be an SMD plug connector or can be designed using SMD technology.

One configuration is that the plug connector is a heavy-duty plug connector. In particular, the plug connector can be intended for currents of greater than 2.5 A.

Another configuration is that the printed circuit board has been soldered firmly onto a second printed circuit board. In particular, the second printed circuit board is a rigid (not flexible) circuit board. Optionally, the second printed circuit board can be a circuit board having a plurality of layers, wherein the printed circuit board has been fixedly soldered onto a central layer of the second printed circuit board.

Another possibility is that the second printed circuit board is connected to the flexible printed circuit board, with the result that, for example, the flexible printed circuit board emerges from the second printed circuit board.

A further configuration is that a plurality of plug connectors are combined by means of a connecting piece. In this case, the connecting piece can be a plastic connecting piece.

An additional development is that a plurality of plug connectors are arranged on two sides of the printed circuit board.

Advantageously, in this case conductor tracks, in particular pairs of conductor tracks, are provided on both sides of the printed circuit board, with the result that, overall, a low inductance can be achieved.

The abovementioned object is also achieved by a plug connector including at least one surface to be soldered onto a printed circuit board.

One development consists in that the plug connector has at least one fixing option which can be used to fix the plug connector on the printed circuit board. In particular, the plug connector can be designed using SMD technology.

The abovementioned object is also achieved by a process for manufacturing a plug device including the following steps:
at least one plug connector is laid flat on a printed circuit board;
the at least one plug connector is soldered to the printed circuit board.

One development consists in that the plug connector is an SMD plug connector.

A further development is that the at least one plug connector is soldered using a reflow method.

Another development is that the at least one plug connector is fixed on the circuit board using a fixing option.

One configuration is that the printed circuit board is a flexible printed circuit board, in particular a Flex PCB.

Exemplary embodiments of the invention will be illustrated and explained below with reference to the drawings, in which:

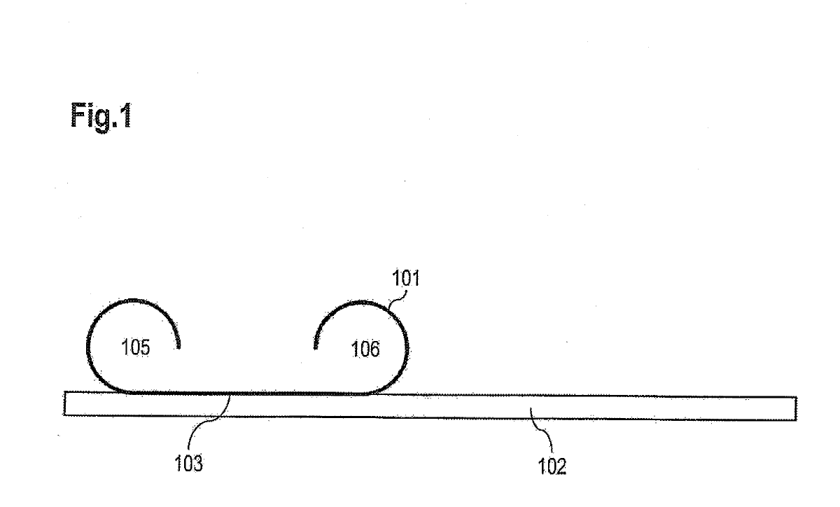

FIG. 1 shows a plug connector with a printed circuit board in a front view;

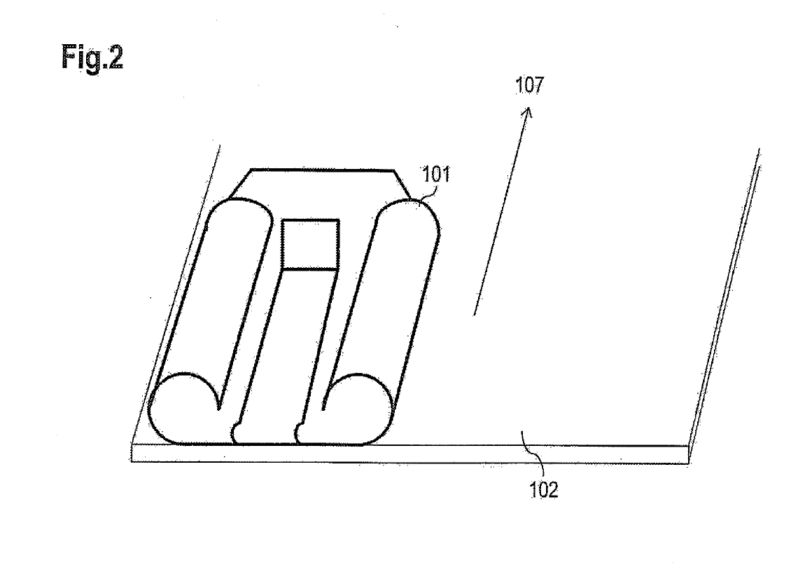

FIG. 2 shows the plug connector with the printed circuit board in a perspective view;

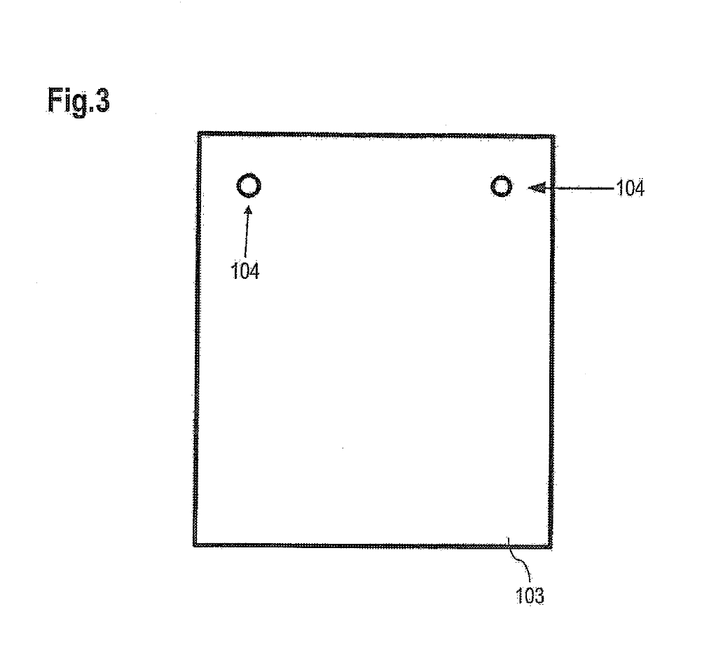

FIG. 3 shows the plug connector from below.

FIG. 1 shows a plug connector 101, which has been soldered onto a printed circuit board 102, in a front view. Bent regions 105 and 106 serve the purpose of making contact with a correspondingly shaped mating piece (not illustrated). The plug connector 101 has been soldered onto the printed circuit board 102 over a surface 103, which is shown here by way of example by the front view in cross section.

The printed circuit board 102 has at least one conductor track, which is connected to the flat soldered joint 103. Furthermore, the printed circuit board 102 is preferably in the form of a flexible printed circuit board, in particular in the form of a Flex PCB, with the result that the plug connector 101 can be connected to the mating piece, for example a plug-type tongue, via the printed circuit board 102.

The plug connector 101 is in particular designed using SMD technology.

FIG. 2 shows a perspective view comprising the plug connector 101 and the printed circuit board 102. In this case, in particular a plurality of plug connectors can be arranged next to one another. The in particular flexible printed circuit board 102 extends along a direction 107, with the result that a cable-like connection can be achieved by means of the combination of the plug connector 101 and the printed circuit board 102.

The solution proposed here is suitable in particular as a plug device, which can be plugged onto existing plug-type tongues with a dimension of 6.3 mm, for example. In this respect, the plug connector 101 can be connected to the plug-type tongue or plugged onto said plug-type tongue. In particular, the plug-type tongues can be fitted substantially horizontally or vertically and can have a mid-distance of 10 mm.

The plug connector 101 is a quick-connect tab terminal designed using SMD technology, for example. This plug connector 101 is soldered flat directly onto the printed circuit board 102, for example a circuit board or a Flex PCB. Such soldering preferably takes place by means of a reflow method.

FIG. 3 shows the underside of the plug connector 101 including latching tabs 104, which are in the form of small elevations or indentations or cutouts, for example. The latching tabs 104 serve the purpose of securing the position of the plug connector 101 on the printed circuit board 102 in order that the position of the plug connector 101 remains substantially unchanged when the solder fuses and the plug connector 101 floats.

Optionally, the plug connector 101 can also be provided with the so-called FASTON principle in order to reduce the forces acting on the flat soldered joint 103 when the plug connector 101 is plugged and released.

The plug connector 101 can also be soldered onto a normal printed circuit board 102 (PCB). It is furthermore possible for a plurality of plug connectors to be used next to one another. In particular, the provision and/or positioning of a plurality of plug connectors or quick-connect tab terminals can be simplified by means of a plastic connecting piece.

The proposed plug device including the plug connector and the printed circuit board and the plug connector itself are suitable for use for high electrical currents (heavy-duty connection) in particular for currents of greater than 2.5 A.

1. A plug device, comprising:
a printed circuit board; and
a plug connector, which is soldered flat onto the printed circuit board.

2. The plug device as claimed in claim 1,
wherein the printed circuit board has at least one conductor track, with which contact is made by the plug connector.

3. The plug device as claimed in claim 2,
wherein the printed circuit board has two conductor tracks, which are arranged at least partially on different sides of the printed circuit board.

4. The plug device as claimed in claim 1,
wherein the printed circuit board comprises a flexible printed circuit board.

5. The plug device as claimed in claim 1,
wherein the printed circuit board has at least two lines, which are connected to at least one plug connector.

6. The plug device as claimed in claim 1,
wherein the plug connector is a quick-connect tab terminal.

7. The plug device as claimed in claim 1,
wherein the plug connector has a means for locking or for releasing the locking.

8. The plug device as claimed in claim 1,
wherein the plug connector has been soldered onto the printed circuit board using a reflow method.

9. The plug device as claimed in claim 1,
wherein the plug connector has a fixing option for securing the position of the plug connector on the printed circuit board.

10. The plug device as claimed in claim 9,
wherein the fixing option comprises an element selected from a group consisting of: a depression; an elevation; and a cutout.

11. The plug device as claimed in claim 1,
wherein the plug connector is an SMD plug connector.

12. The plug device as claimed in claim 1,
wherein the plug connector is a heavy-duty plug connector.

13. The plug device as claimed in claim 1,
wherein the plug connector is intended for currents of greater than 2.5 A.

14. The plug device as claimed in claim 1,
wherein the printed circuit board is soldered firmly onto a second printed circuit board.

15. The plug device as claimed in claim 1,
wherein a plurality of plug connectors are combined by means of a connecting piece.

16. The plug device as claimed in claim 15,
wherein the connecting piece is a plastic connecting piece.

17. The plug device as claimed in claim 1,
wherein a plurality of plug connectors are arranged on two sides of the printed circuit board.

18. A plug connector, comprising:
at least one surface configured to be soldered onto a printed circuit board.

19. The plug connector as claimed in claim 18,
which has at least one fixing option which can be used to fix the plug connector on the printed circuit board.

20. The plug connector as claimed in claim 18,
wherein the plug connector is designed using SMD technology.

21. A process for manufacturing a plug device, comprising:
at least one plug connector is laid flat on a printed circuit board;
the at least one plug connector is soldered to the printed circuit board.

22. The process as claimed in claim 21,
wherein the plug connector is an SMD plug connector.

23. The process as claimed in claim 21,
wherein the at least one plug connector is soldered using a reflow method.

24. The process as claimed in claim 21,
wherein the at least one plug connector is fixed on the circuit board using a fixing option.

25. The process as claimed in claim 21,
wherein the printed circuit board is a flexible printed circuit board.
